(19) United States
(12) Patent Application Publication
(10) Pub. No.: US 2019/0313599 A1
(43) Pub. Date: Oct. 17, 2019

(54) BIOSECURITY LIVESTOCK FLOOR SYSTEM

(71) Applicant: Hansen Ag Solutions, LLC, Clive, IA (US)

(72) Inventors: Lloyd D. SNELL, Ames, IA (US); David MEESTER, Fresno, CA (US)

(21) Appl. No.: 16/382,955

(22) Filed: Apr. 12, 2019

Related U.S. Application Data
(60) Provisional application No. 62/657,140, filed on Apr. 13, 2018.

(51) Int. Cl. A01K 1/02; E04B 5/43; A01K 1/00; A01K 1/015

(52) U.S. Cl. CPC A01K 1/0218; E04B 5/43; A01K 1/0151; A01K 1/0209; A01K 1/0076; A01K 1/0005

(57) ABSTRACT

An improved biosecurity livestock floor system for safely supporting and farrowing livestock. The floor system improves the safety of the livestock and the user. The floor system includes a containment area with containment panels, and a safety area with safety area floor panels, which house an animal and is adjoined, and separated, by the Flying-W configuration of the rib structure. This configuration protects offspring of the animal in the adjoining safety area from being injured or killed.

### CROSS REFERENCE TO RELATED PATENT APPLICATION(S):

This present utility patent application claims priority to U.S. Provisional Patent Application No. 62/657,140 entitled “Improved Biosecurity Livestock Confinement Crate and Floor System” filed on Apr. 13, 2018, which is fully incorporated by reference herein.

### FIELD OF THE DISCLOSURE

This disclosure relates to an improved biosecurity livestock floor used in agriculture and elsewhere. More specifically, and without limitation, this disclosure relates to an improved biosecurity livestock floor system for use in supporting and farrowing livestock.

### BACKGROUND OF THE DISCLOSURE

Livestock confinement crates including, but not limited to, farrowing crates, gestational crates, sow stalls, etc. are well known in the art. Livestock confinement crates are almost always comprised of metal and are used to enclose a sow or other livestock.

Livestock production regularly utilizes different production methods and facilities to more efficiently manage unique life cycle periods. For instance in pork production, a sow barn provides for the breeding, resting, and nursing of new production animals. Nursery barns are utilized to efficiently utilize barn space by raising piglets from weaning to a finishing barn starting weight. Finally, a finishing barn completes the growth cycle to market weight.

Livestock confinement crates are commonly utilized on pork farms, ranches, and/or livestock ranches. A farrowing crate is commonly used to constrain a sow and protect the piglets which she is nursing.

Sow farming confinements are the means by which producers replenish market hogs and provide products to consumers, such as pork, bacon, gammon, and other hog protein products. Hog farming comes in a variety of forms including, but not limited to, intensive commercial farming, small scale farming, and free-range farming. In modern hog farming, a commercial farm may house thousands of hogs in climate-controlled bio-security enhanced buildings.

Due to this high demand, exceeding a billion hogs annually harvested, hog production and producers must and do become more efficient in all areas. These areas range from water usage, calories to mass conversions, equipment cost and durability, and most importantly animal well-being.

While in a sow barn, a sow typically spends an entire life in a single building, therefore, the interactions that the sow encounters are extremely important. Generally, the main types of interactions for sows include: (1) human/handler interactions; (2) interactions with their piglets; and (3) interactions with equipment including, but not limited to, livestock confinement crates such as farrowing crates. Injury or death due to equipment interactions including cuts and entrapment are important consideration in equipment design and function. Finally, systems designed to protect the herd from disease, improve human interactions, air filtration, and the minimization of disease breeding environments.

Current livestock confinement crates may restrict handler visual and physical access to the sow. Restricted access increases the potential for injury of the handler during movement and health and well-being interactions.

With the high demand for hogs, the loss of a piglet due to a negative interaction between the sow and the piglet which results in injury or death is unacceptable. The sow piglet interaction must provide safe zones for nursing and transition zones at the head and rear of the sow. Furthermore, the crate must allow the piglets not to become trapped between the sow and the confinement equipment, either while nursing or during the sow motions, such as standing up, lying down, rolling, or other activities. The confinement must minimize or eliminate all sharp corners and edges which could cause injury. Not all confinement systems, due to design and manufacturing methods control these requirements.

A confinement sow facility most importantly must maintain a healthy environment that is bio-safe. In a modern facility, bio-safe means air filtration, waste management, and minimization of areas that promote the growth of disease. Not all confinement equipment designs eliminate the internal cavities that promote disease growth. Most notably, these spaces are created by confinement equipment built of square, rectangular, or round structural tubing or pipe. Furthermore, when these hollow forms are galvanized, additional holes are required for the process to prevent structural damage. These unclosed holes allow access to the entire internal volume of the structural tubing or pipe. An internal volume that is warm, dark, wet, and inaccessible for cleaning. A perfect location for the hosting of disease and pests.

Current livestock confinement crates including, but not limited to, farrowing crates which are bulky, expensive, and require significant assembly effort when delivered. Furthermore, current livestock confinement crates are designed without full concern for bio-security which results in uncleanable or difficult to clean elements, such as structural tubing. In a modern facility, and for purposes of this disclosure, biosecurity is the prevention of rapid disease transmission within the confinement system.

Current methods of fabrication for livestock confinement crates use various standard metal forms, such as rod, tubing, bar, and plate steel. Current livestock confinement crates utilize these primary materials to cut, form, and weld the pieces into a front, sides, a top, and a rear planar panel sub-assemblies. These sub-assemblies are shipped and assembled on location.

Furthermore, current livestock confinement utilizes numerous parts welded together which are more likely to fail and require more in barn repairs and maintenance.

In addition to methods and fabrication of livestock confinement crates, current methods and fabrication of floor assemblies are independent of the confinement design. Thus, the comprehensive fully integrated crate and floor system do not exist. Most often, the two components are supplied by multiple suppliers and connect with standard fasteners. Additionally, current flooring arrangements used in livestock confinement areas are, or may not be bio-secure.

Furthermore, current arrangements for housing and breeding livestock are not bio-secure. Bio-secure can be defined as a preventive measure designed to reduce the risk of transmission of infectious diseases in livestock. In livestock containment areas, where many livestock are often housed in close proximity, diseases and other complications rapidly spread throughout the facility.

Thus, it is a primary objective of this disclosure to provide a solution to these problems and more. This disclosure provides a bio-secure floor system. This disclosure provides a bio-secure floor system which is easy to assemble and relatively affordable. Furthermore, this disclosure provides a livestock floor system that is strong enough to support all ranges of livestock. Furthermore, this disclosure provides a livestock floor system that can be easily cleaned and maintained.

Thus, it is an objective of this disclosure to provide a solution to these problems and more. This disclosure provides a means to improve operator interaction with the sow, increase piglet safety, greater concern for bio-security, increased durability through design and manufacturing, and lower cost by utilizing more efficient manufacturing methods. This disclosure further provides an improved biosecurity livestock confinement crate system and an improved biosecurity livestock floor system that is easy to ship and transport, easy to assemble, requires minimal installation time in new or retrofit facilities, etc. Additionally, the disclosure herein solves numerous problems facing the hog confinement facilities. These problems include, but are not limited to, stability of the crate system; rigidity and durability of the crate system; stability of the floor system; rigidity and durability of the floor system; etc. Finally, this disclosure introduces a farrowing crate system that utilizes advanced manufacturing solutions to reduce cost and improve component, sub-assemblies and final assembly function and durability.

Therefore, for all the reasons stated herein, there is a need in the art for an improved biosecurity livestock floor system for safely confining and farrowing livestock in a bio-secure manner.

Thus, it is an object of the disclosure to provide an improved biosecurity livestock floor system that improves upon the state of the art.

Another object of the disclosure is to insure facility operators are safe while interacting with the animal.

Yet another object of the disclosure is to provide an improved biosecurity livestock floor system that is easy to use and maintain.

Another object of the disclosure is to provide an improved biosecurity livestock floor system that is efficiently manufacturable.

Yet another object of the disclosure is to provide an improved biosecurity livestock floor system that is relatively more affordable.

Another object of the disclosure is to provide an improved biosecurity livestock floor system that is easy to assemble.

Yet another object of the disclosure is to provide an improved biosecurity livestock floor system that can be assembled and disassembled quickly.

Another object of the disclosure is to provide an improved biosecurity livestock floor system that retains animal contaminants in a designated contaminant area.

Yet another object of the disclosure is to provide an improved biosecurity livestock floor system that is safe and meets the requirements for extended animal confinement within the crate.

Another object of the disclosure is to provide an improved biosecurity livestock floor system that is safe for the animals engaging with the floor system.

Yet another object of the disclosure is to provide an improved biosecurity livestock floor system that works with both mature and young livestock.

Another object of the disclosure is to provide an improved biosecurity livestock floor system that allows livestock to stand, sit, and walk around.

Yet another object of the disclosure is to provide an improved biosecurity livestock floor system that is strong enough to support all ranges of livestock.

Another object of the disclosure is to provide an improved biosecurity livestock floor system that is bio-secure.

Yet another object of the disclosure is to provide an improved biosecurity livestock floor system that can quickly pass animal contaminants.

Yet another object of the disclosure is to provide an improved biosecurity livestock floor system that is easy to clean.

Another object of the disclosure is to provide an improved biosecurity livestock floor system that is structurally sound.

Yet another object of the disclosure is to provide an improved biosecurity livestock floor system that allows livestock to stand or lay down without causing injury or death to any of the litter.

Another object of the disclosure is to provide an improved biosecurity livestock floor system that is stable.

Yet another object of the disclosure is to provide an improved biosecurity livestock floor system that can house large animals and withstand the forces generated by large animals.

Another object of the disclosure is to provide an improved biosecurity livestock floor system that is resilient.

Yet another object of the disclosure is to provide an improved biosecurity livestock floor system that provides some flexibility to accommodate livestock.

Another object of the disclosure is to provide an improved biosecurity livestock floor system that requires little to no tools for assembly.

Yet another object of the disclosure is to provide an improved biosecurity livestock floor system that reduces bacteria build-up on the floor of a livestock floor.

Another object of the disclosure is to provide an improved biosecurity livestock floor system that allows proper ventilation.

Yet another object of the disclosure is to provide an improved biosecurity livestock floor system that reduces entrapment of contaminants.

Another object of the disclosure is to provide an improved biosecurity livestock floor system that minimizes risk of injury or death to the animal during nursing.

Yet another object of the disclosure is to provide an improved biosecurity livestock floor system that minimizes tools for assembly.

Another object of the disclosure is to provide an improved biosecurity livestock floor system that can be quickly final assembled on site.

Yet another object of the disclosure is to provide an improved biosecurity livestock floor system that can be formed and manufactured by high efficiency manufacturing processes.

Another object of the disclosure is to provide an improved biosecurity livestock floor system that is easy to ship.

Yet another object of the disclosure is to provide an improved biosecurity livestock floor system that is light and durable without reducing structural performance.

Another object of the disclosure is to provide an improved biosecurity livestock floor system that can easily attach to a confinement crate or other components and/or features used in livestock farming.

Another object of the disclosure is to provide an improved biosecurity livestock floor system that is customizable.

Yet another object of the disclosure is to provide an improved biosecurity livestock floor system that accommodates manufacturing deviations in assembly.

Another object of the disclosure is to provide an improved biosecurity livestock floor system that can be adapted to other primary and secondary systems.

These and other objects, features, or advantages of the disclosure will become apparent from the specification, figures and claims.

### SUMMARY OF THE DISCLOSURE

An improved biosecurity livestock floor system (also referred to as “livestock floor system” or “system” throughout the disclosure) for safely confining and farrowing livestock is presented. The system enables high-volume manufacturing to minimize parts count, eliminates most welding, maximizes functionality, and reduces direct labor costs during manufacturing, installation, and utilization.

The livestock floor system presented improves upon the safety of the livestock and the user(s). The livestock floor system presented improves upon the biosecurity of the livestock confinement. The livestock floor system presented includes a designated confinement area which houses a parent livestock. The parent livestock has access to feed and the ability to stand or lay down. The containment areas are adjoined, and separated, by the Flying-W configuration of the rib structure. The sow confinement area allows the piglets to transfer to opposing containment areas through safe zones at the head and rear of the sow. Furthermore, this configuration protects a litter of livestock in the adjoining safety area from being injured or killed when a parent livestock stands up, lies down, or repositions. The configuration is unique in that it protects the litter while still allowing the sow to lie down. The configuration is unique in that it can support heavy livestock and still provide a plurality of bio-secure areas.

The livestock floor system is structurally sound but also flexible due to the unique design. The livestock floor is easy to assemble and safe to use. Previous methods of creating and assembling components of a livestock floor such as a farrowing floor were burdensome, expensive, and required more hardware to assemble and secure sub-assemblies of the crate assembly. The new methods and components described herein solve these issues, among others, that have remained unresolved for many years. The livestock floor system presented herein utilizes novel components in a unique way to create a safe and useful structure for the livestock industry that can be assembled quickly and efficiently. The livestock floor system presented herein creates a bio-secure environment that reduces contaminants which have harmful effects on livestock and livestock litters, especially in the nursing process.

### BRIEF DESCRIPTION OF THE DRAWINGS

FIG. 1 is a perspective view of an improved biosecurity livestock system; the view showing a confinement crate; the view showing an improved biosecurity livestock floor system;

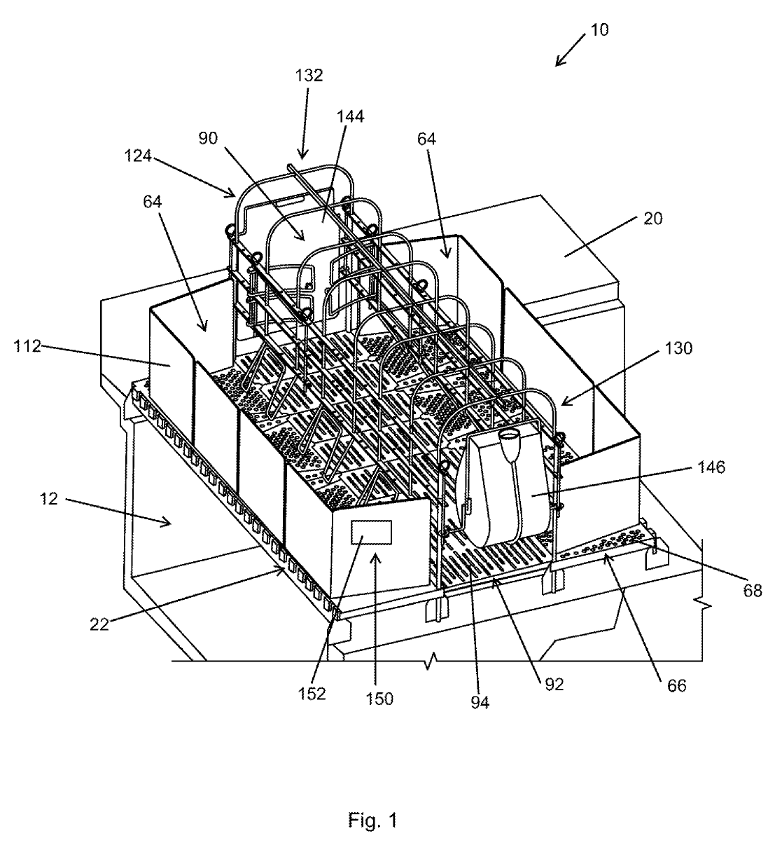

FIG. 2 is a section view of the improved biosecurity livestock floor system as shown in FIG. 1; the view showing a containment area; the view showing a safety area;

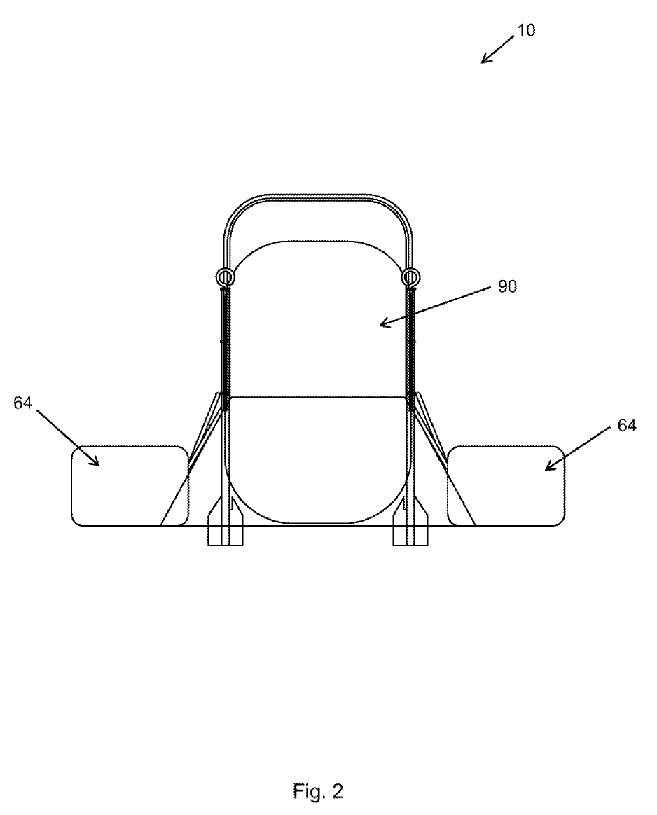

FIG. 3 is a perspective view of a partial improved biosecurity livestock floor system as shown in FIG. 1; the view showing a bio-waste containment pit; the view showing a floor; the view showing a shelf of a bio-waste containment pit;

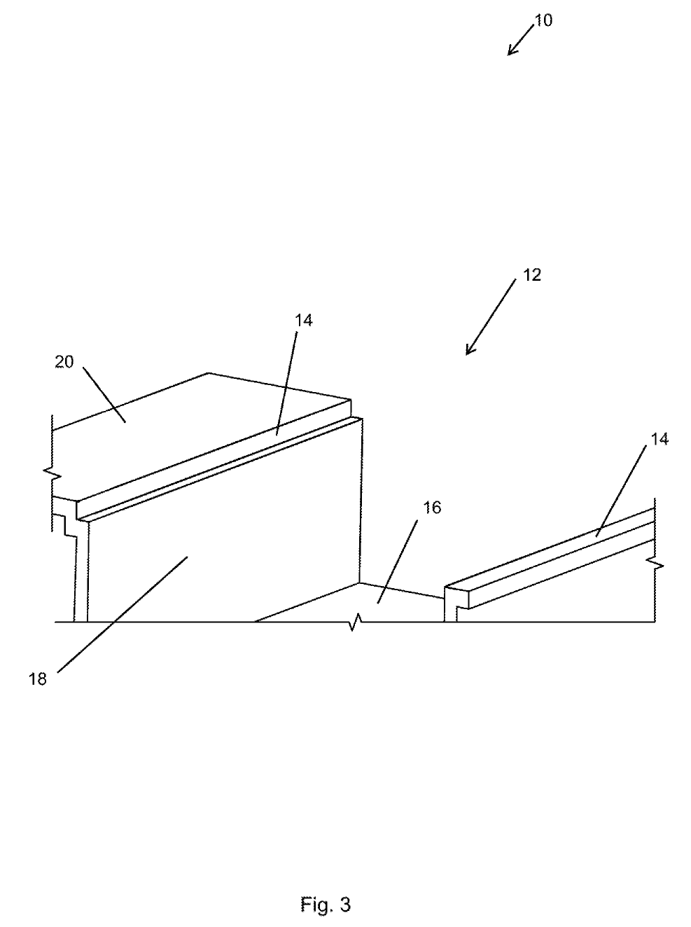

FIG. 4 is a perspective view of a partial improved biosecurity livestock floor system as shown in FIG. 1; the view showing a floor deck assembly connected to a shelf of a bio-waste containment pit; the view showing a floor; the view showing a floor deck assembly having a plurality of floor beams, a plurality of stiffeners and a plurality of floor plates; the view showing adjacent floor deck assembly installations installed for use with a safety area floor;

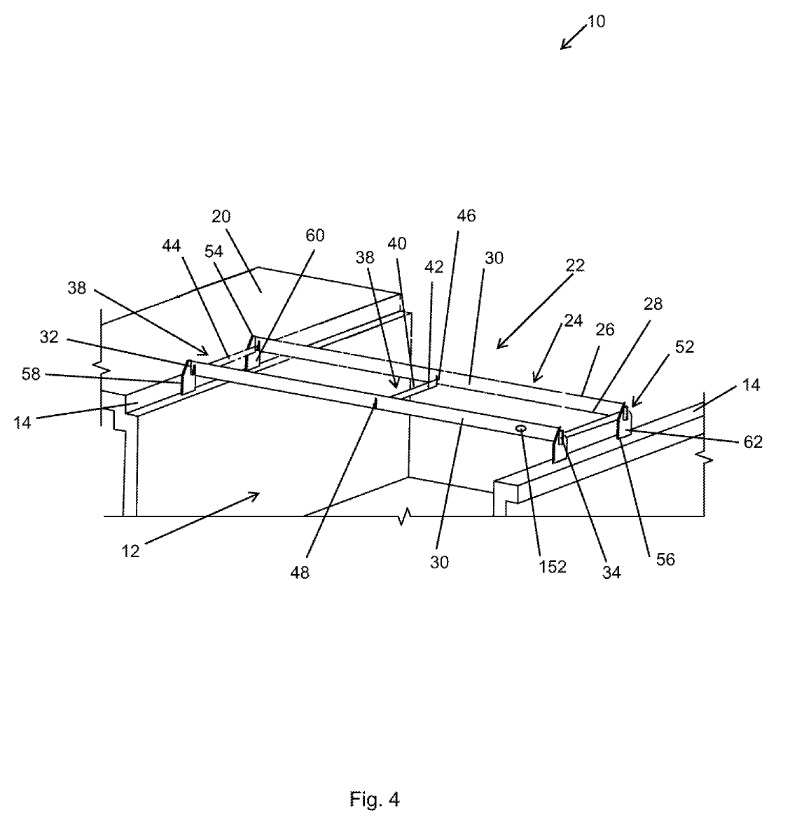

FIG. 5 is a perspective view of a partial improved biosecurity livestock floor system as shown in FIG. 1; the view showing a floor deck assembly connected to a stiffener;

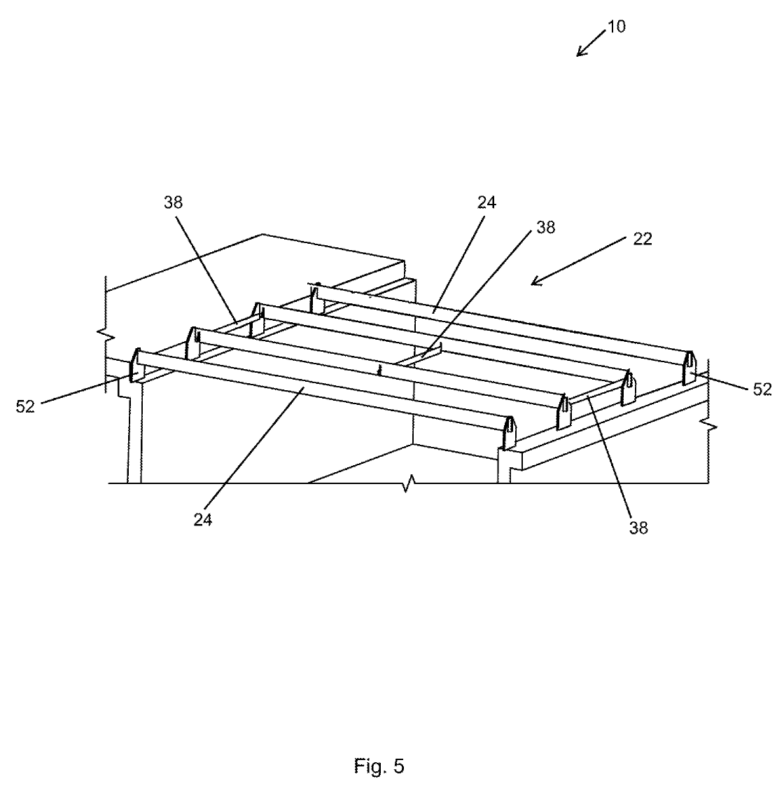

FIG. 6 is a perspective view of a safety area floor panel;

FIG. 7 is a top perspective view of a safety area floor panel;

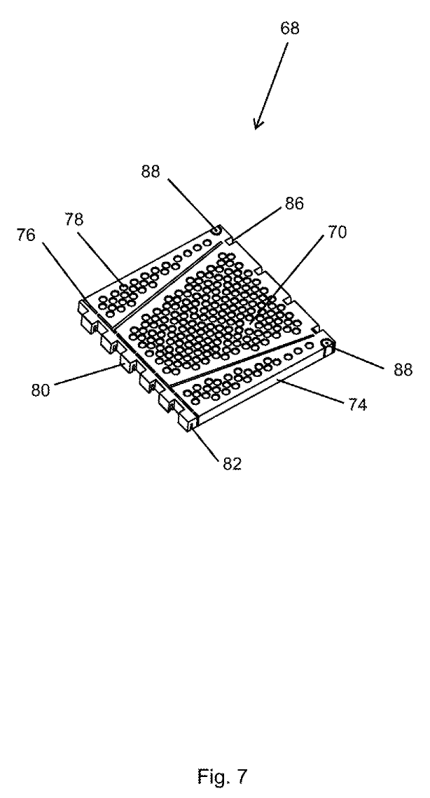

FIG. 8 is a close up perspective view of a partial improved biosecurity livestock floor as shown in FIG. 1; the view showing a floor assembly; the view showing a safety area floor; the view showing a crate;

FIG. 9 is a bottom perspective view of a confinement area floor panel;

FIG. 10 is a close up perspective view a partial improved biosecurity livestock floor; the view showing a plurality of confinement area floor panels interlocking with a plurality of safety area floor panels;

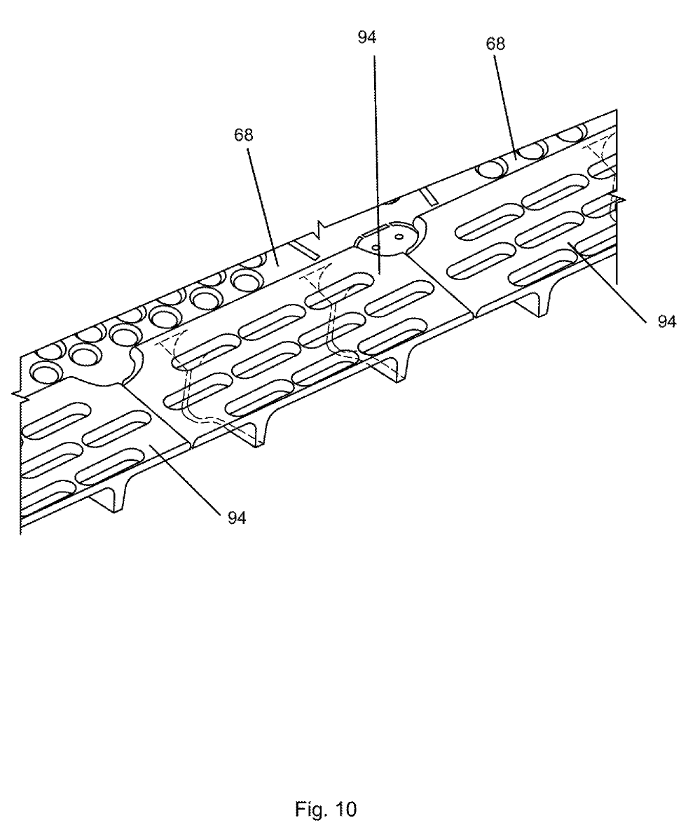

FIG. 11 is a close up perspective view of a partial improved biosecurity livestock floor; the view showing a confinement area with confinement area floor panels; the view showing a safety area having safety panels; the view showing a partial crate;

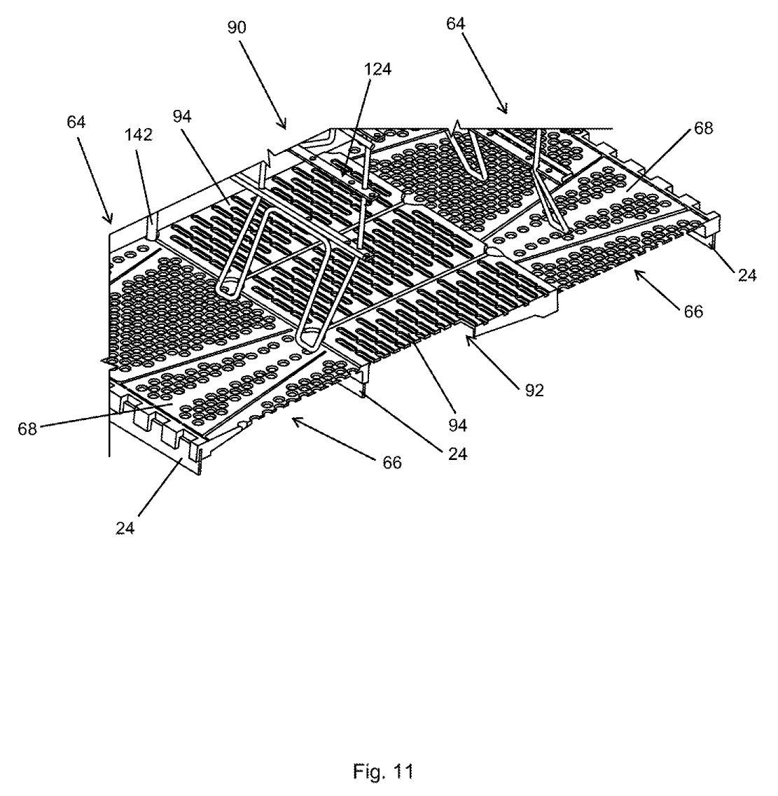

FIG. 12 is a close up perspective view of an improved biosecurity livestock floor as shown in FIG. 1; the view showing nursery panels; the view showing nursery panels operably connected to a safety area floor panels;

FIG. 13 is a perspective view of a partial improved biosecurity livestock floor system as shown in FIG. 1; the view showing a floor deck assembly connected to a shelf of a bio-waste containment pit; the view showing a floor; the view showing a floor deck assembly having a plurality of floor beams, a plurality of stiffeners and a plurality of floor plates; the view showing adjacent floor assembly installations installed for use with a safety area floor; the view showing a crate attached to the floor deck assembly;

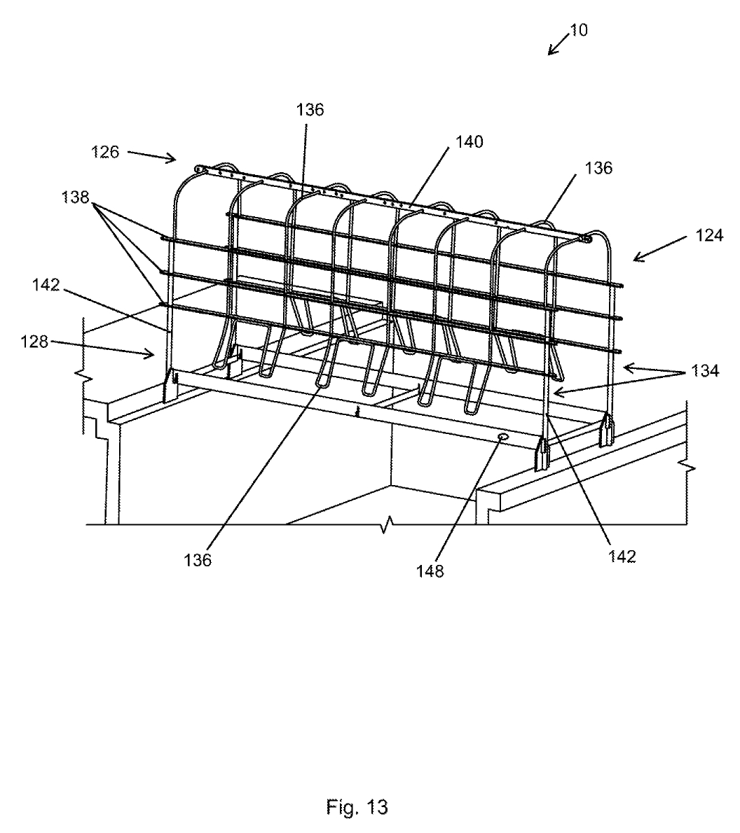

FIG. 14 is a perspective view of a partial improved biosecurity livestock floor system as shown in FIG. 1; the view showing an opposing wall of a crate; the view showing an opposing wall of a crate attached to a plurality of floor plates;

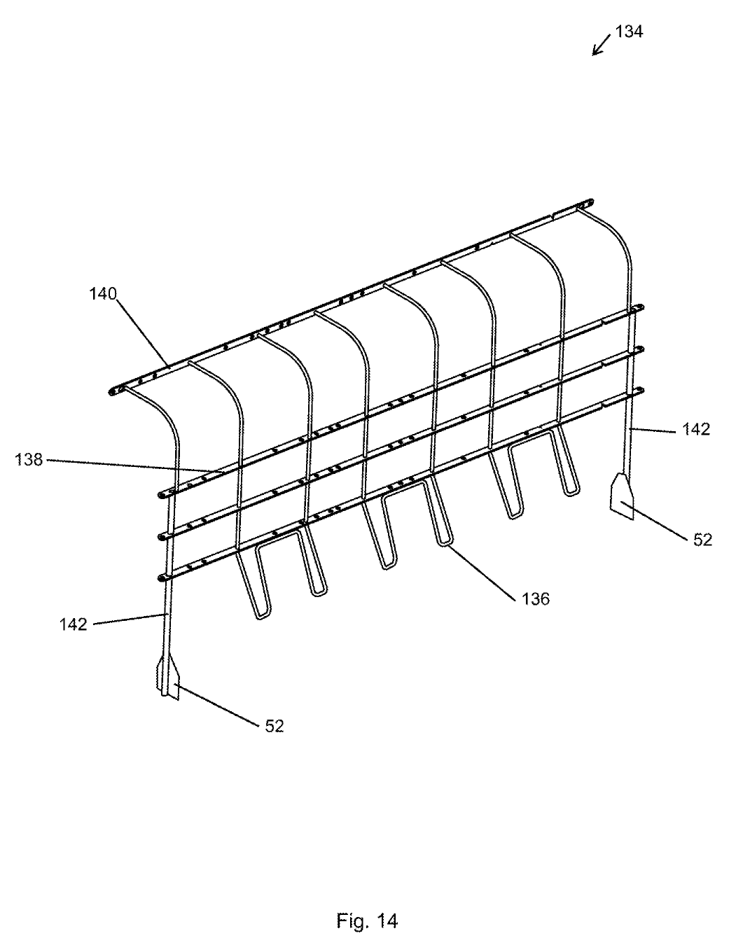

FIG. 15 is a perspective view of a partial improved biosecurity livestock floor system as shown in FIG. 1; the view showing a hardware management system.

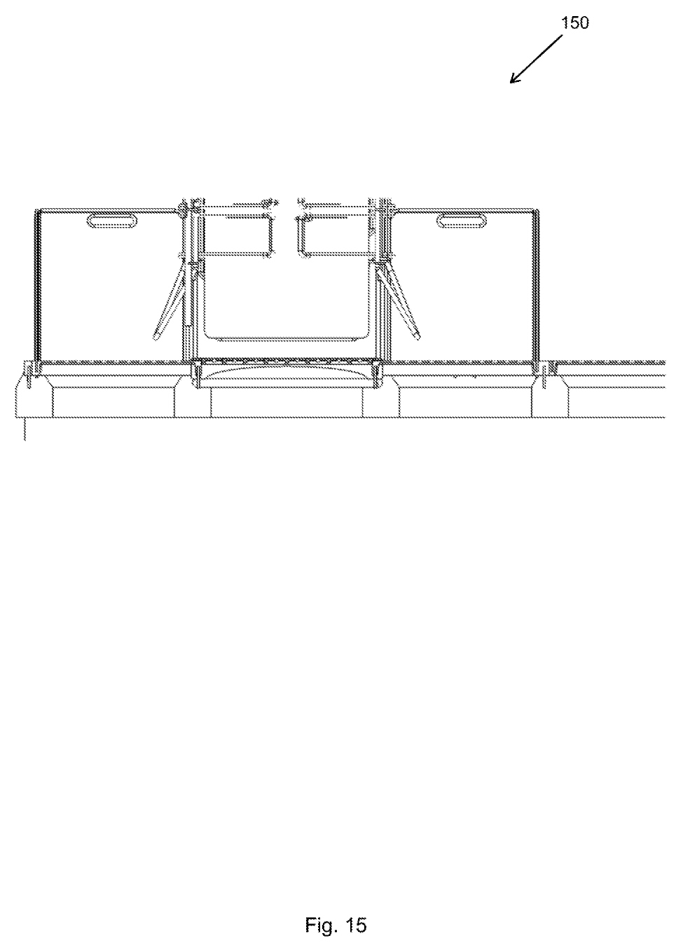

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

### System:

With reference to the figures, an improved biosecurity livestock floor system 10 (or simply “system 10”, “a floor system 10”, or “a livestock floor system 10”) for supporting and confining livestock is presented. The system 10 is used in association with many purposes involving livestock including, but not limited to, a farrowing crate, to improve animal well-being, improve facility biosecurity control, and manage bio-waste (feces and urine discharges) movement within production confinements. System 10 may be utilized in association with any type of livestock including, but not limited to, swine without departing from the scope of the disclosure. Furthermore, the term “swine” is utilized throughout the disclosure to refer to pigs, sow, hogs, and the like without any limitation. System 10 is used in association with a bio-waste containment pit 12, a floor deck assembly 22, a safety area 64, a safety area floor panel 68, a confinement area 90, and a confinement area floor panel 94.

System 10 may also be used in association with at least one floor assembly 22. The floor assemblies 22 may also be referred to as a floor deck assembly 22 without departing from the disclosure. The floor deck assemblies 22 of system 10 are configured to hold at least one safety area floor panel 68 and at least one confinement area floor panel 94. In turn, the floor deck assembly 22 supports livestock and provides a bio-secure means of facilitating in the passing of bio-waste, as well as other functions to be further described and incorporated herein. Additionally, the floor deck assembly 22 may include a beam 24, a stiffener 38, and a floor plate 52, among other components.

In the arrangement shown, as one example, the at least one confinement area floor panel 94 is attached to the floor deck assembly 22. In this way, the at least one confinement area floor panel 94 forms the confinement area floor 92 of the confinement area 90. In the arrangement shown, as one example, the at least one safety area floor panel 68 is attached to the floor deck assembly 22. In this way, the at least one safety area floor panel 68 forms the safety floor 66 of the safety area 64. In the arrangement shown, as one example, the safety area 64 and the confinement area 90 may be configured adjacent to one another. Also, it should be noted that the confinement area floor panel 94 may also be referred to as a confinement panel 94 without departing from the disclosure and the safety area floor panel 68 may be referred to as a safety panel 68 without departing from the disclosure.

System 10 may be used in association with other features as well. System 10 may be used in association with a nursery panel 112 and a crate 124. It should be noted that the nursery panel 112 may also be referred to as a guard 112 without departing from the disclosure. Nursery panel 112 and crate 124 may be configured to attach to the floor system 10. In this arrangement, as is shown in one example, nursery panel 112 and crate 124 are configured to confine livestock. System 10 may also be used in association with a feeder 146, at least one sensor 148, a hardware management system 150, an application 152, the application 152 being associated with a user (not shown in figures) and an internet enabled and/or controller enabled device such as a mobile device (not shown in figures).

The system 10 is used in association with all of these components, among other features, systems, and components as is described herein and shown in the figures.

### Bio-waste Containment Pit:

In the arrangement shown, as one example, floor system 10 is used in association with a bio-waste containment pit 12. The bio-waste containment pit 12 may also be referred to as a containment pit 12 or a contaminant pit 12 without departing from the disclosure. Bio-waste containment pit 12 is formed of any suitable size, shape, and design and is configured to collect contaminants including, but not limited to, feces and urine, and to provide for easy clean-out of livestock waste. In other words, in the arrangement shown, as one example, bio-waste containment pit 12 is configured to provide a means of maintaining a bio-secure livestock system. In the arrangement shown, as one example, bio-waste containment pit 12 is a large opening located below the floor deck assembly 22. In the arrangement shown, as one example, the bio-waste containment pit 12 is a generally rectangular opening with one, two, three, four, five, six, seven, eight, nine, or more floor systems 10. In the arrangement shown, as one example, bio-waste containment pit 12 includes a pre-cast shelf or lip 14, a bottom 16, and a sidewall 18, among other components.

Shelf: In the arrangement shown, as one example, bio-waste containment pit 12 includes a shelf 14. Shelf 14 may also be referred to as a lip 14 without departing from the disclosure. Shelf 14 is formed of any suitable size, shape and design and is configured to provide an attachment means of the floor deck assembly 22. In this arrangement, as is shown, shelf 14 allows the floor deck assembly 22 to be positioned lower than the floor 20 of the surrounding area such that no or minimal steps are required for livestock to enter or exit the confinement area 90. In this way, the shelf 14 lowers the entire above components of system 10 so that the confinement area floor 92 and the safety area floor 66 are approximately level with the surrounding, environment or building floor 20.

Bottom: In the arrangement shown, as one example, bio-waste containment pit 12 includes a bottom 16. Bottom 16 is formed of any suitable size, shape and design and is configured to provide a flat surface to collect bio-waste. Additionally, bottom 16 is configured to provide a surface which is easy to clean and wash out. In the arrangement shown, as one example, bottom 16 is a flat or tapered surface spaced a distance below the floor deck assembly 22. In the arrangement shown, as one example, bottom 16 is formed of concrete so the surface can be easily maintained and easily cleaned. However, any other material or shape for bottom 16 is hereby contemplated for use.

Sidewall: In the arrangement shown, as one example, bio-waste containment pit 12 includes a sidewall 18. Sidewall 18 is formed of any suitable size, shape and design and is configured to provide a flat surface to contain contaminants below the rest of system 10. Bio-waste containment pit 12 may include any number of sidewalls 18 without departing from the scope of the disclosure. For example, the bio-waste containment pit 12 may comprise one, two, three, four, or more sidewalls 18. Furthermore, sidewall 18 is configured to provide a surface which is easy to clean and easy to wash out. In the arrangement shown, as one example, sidewall 18 is a flat, vertical surface spaced a distance from an opposing sidewall 18, the pair of opposing sidewalls, along with a bottom 16 forming a channel, or bio-waste containment pit 12. In the arrangement shown, as one example, sidewall 18 is formed of concrete so the surface can be easily maintained and cleaned. However, any other material or shape for opposing sidewalls 18 is hereby contemplated for use. An example of another shape for opposing sidewalls 18 may be a semi-circular channel or canal such that a wash out is created.

### Floor Deck Assembly:

In the arrangement shown, as one example, system 10 is used in association with a floor deck assembly 22. Floor deck assembly 22 may also be referred to as a floor assembly 22 without departing from the disclosure. Floor deck assembly 22 may be formed of any suitable size, shape, and design and is configured to provide an improved biosecurity floor which is strong enough to support required livestock. In other words, the floor deck assembly 22 is configured to provide adequate strength and durability to withstand repeated loading and unloading cycles due to animal movements and activities. Additionally, the floor deck assembly 22 is configured to provide a means against biosecurity risks.

In the arrangement shown, as one example, floor deck assembly 22 configured to provide support to a safety area floor 66 and a confinement area floor 92 that supports direct flow of bio waste into the bio-waste containment pit 12 below the floor deck assembly 22. This system is important to biosecurity. In this way, in this arrangement, a bio-secure floor deck assembly 22 is presented that prevents buildup of contaminants in underside spaces and cleans easily.

In the arrangement shown, as one example, the floor deck assembly 22 includes at least one beam 24, at least one stiffener 38, and at least one floor plate 52. In the arrangement shown, as one example, the at least one beam 24, the at least one stiffener 38, and the at least one floor plate 52 are configured to support the other components of system 10 presented above. In the arrangement shown, as one example, various types of panels 68/94 are configured depending upon the position of the system 10. In the confinement area 90, a confinement area floor panel 94 is used in association, and in interlocking engagement, with safety area floor panels 68.

Beams: In the arrangement shown, as one example, the structure of the floor deck assembly 22 is used in association with at least one beam 24. Beam 24 is formed of any suitable size, shape, and design and is configured to provide support for the panels 68/94. In the arrangement shown, as one example, beam 24 has a top 26, a bottom 28, a plurality of sidewalls 30, a plurality of ends 32, and at least one notch 34.

In the arrangement shown, as one example, beams 24 are a generally flat, rectangular bar turned on its slender side to maximize strength. Additionally, beams 24 are arranged along their slender side to maximize the opening space for which bio-waste can fall to the bio-waste containment pit 12 below. This minimizes how many bio-wastes are caught on beams 24 to almost nothing, while maximizing biosecurity of system 10.

In the arrangement shown, as one example, beams 24 extend the length of system 10 from one floor plate 52 at one end of the system 10 to another floor plate 52 at the opposite end. In the arrangement shown, as one example, beams 24 are notched at each end of the length of the beam 24 to interlock with the floor plates 52, attached to the end rods 142 of the crate 124. Additionally, in the arrangement shown, as one example, beams 24 are reinforced against bending, bowing, or torsional twist along their lengths by at least one stiffener 38. Stiffener 38 is further described herein.

In the arrangement shown, as one example, beams 24 are made of stainless steel. Stainless steel is a material that can handle long-term exposure to bio-waste without structural failure. However, beams 24 could be formed of any other material without departing from the scope of the disclosure. Other materials include, but are not limited to, polymers, fiberglass, steel, aluminum, enhanced polymers, polymer composites, and the like.

Stiffeners: In the arrangement shown, as one example, floor deck assembly 22 is used in association with at least one stiffener 38. Stiffeners 38 are formed of any suitable size, shape and design and are configured to stiffen the beams 24, adding strength to the floor deck assembly 22. In the arrangement shown, as one example, stiffener 38 has a top 40, a bottom 42, a plurality of sidewalls 44, at least one end 46, and a notch 48 extending from one sidewall to the other sidewall and extends from the top or bottom edge towards the neutral axis.

In the arrangement shown, as one example, stiffeners 38 are used with beams 24 to form a grid-like pattern of supports for the floor panels 68/94. In the arrangement shown, stiffeners 38 are formed of a generally flat, rectangular stainless steel bar connected to the sidewall 30 of a beam 24 on each end 46 of the stiffener 38 using interlocking slots, no welding. The interlocking slots allow the components of the floor deck assembly 22 to be shipped flat and simply assembled at the barn location. Furthermore, the stiffeners 38 are located below the floor area panels 68/94 and the floor area panels 68/94 only interlock with the floor beams 24. In the arrangement shown, this grid-like pattern prevents flexing in the system 10 both during assembly of the system 10, and during use.

Furthermore, in the arrangement shown, as one example, the final structural integrity of the floor deck assembly 22 design is complete when the floor area panels 68/94 are interlocked with the beams 24 and/or stiffeners 38. In this way, as is shown in one example, the stiffeners 38 may be light and may not be required due to the stabilizing, interlocking features of the floor panels 68/94.

In the arrangement shown, as one example, the stiffeners 38 include a notch 48 at each end 46. The notches 48 of the stiffeners 38 enable the stiffeners 38 to be attached to the beams 24 by interlocking. In this way, installation requires no tools or welding, no heavy lifting, and results in a more efficient installation or disassembly.

In the arrangement shown, as one example, stiffeners 38 are made of stainless steel. However, stiffeners 38 may be formed of any other material without departing from the disclosure. Other materials include, but are not limited to, polymers, fiberglass, steel, aluminum, enhanced polymers, polymer composites, and the like.

Floor Plate: In the arrangement shown, as one example, system 10 is used in association with at least one floor plate 52. At least one floor plate 52 may be formed of any suitable size, shape and design and is configured to provide support for system 10, as well as, attach system 10 to the lip or shelf 14 and/or floor 20.

In the arrangement shown, as one example, floor plate 52 includes a top 54, a bottom 56, at least one side 58, a first surface 60, and a second surface 62. In the arrangement shown, as one example, floor plate 52 is a generally flat, square piece of steel plate with tapered edges on the top two corners of the top 54 of the floor plate 52.

In the arrangement shown, as one example, floor plate 52 is formed to receive a portion of the end rod 142 by connecting a portion of the end rod 142 to the floor plate 52. The end rod 142 may be connected to the floor plate 52 by any means without departing from the disclosure including, but not limited to, welding. End rod 142 is further described herein. In the arrangement shown, as one example, a portion of end rod 142 is connected to a first surface 60 of the floor plate 52, while the second surface 62 is connected to the beam 24 and/or floor deck assembly 22. In this arrangement, as is shown, floor plate 52 is designed to attach the end rod 142, and thus the other components of system 10, such as the crate 124, to the floor deck assembly 22 and/or the lip or shelf 14 of the bio-waste containment pit 12.

In the arrangement shown, as one example, a floor plate 52 is located at the end 32 of beam 24 and attached to beam 24 via the interlocking notches 34 of beam 24 and slots 53 of the floor plate 52. In this arrangement, as is shown, each floor plate 52 is positioned at the end 32 of a beam 24 so as to attach the components of system 10 to the floor deck assembly 22.

In the arrangement shown, as one example, the at least one floor plate 52 is attached to the end rod 142 of system 10 by welding. Additionally, in the arrangement shown, the at least one floor plate 52 is attached to the floor deck assembly 22 by the notch 34 of beam 24; and optionally welding the beam 24 in place with the floor plate 52. However, any other attachment means is hereby contemplated for use without departing from the disclosure, including but not limited to, friction fitting, bolting, threading, gluing, and the like.

Furthermore, in the arrangement shown, as one example, four or six floor plates 52 are used in the design of the system 10. However, any number of floor plates 52 is hereby contemplated for use, including one, two, three, five, or more floor plates 52.

In the arrangement shown, as one example, the at least one floor plate 52 is made from flattened or plated steel. However, any other material which is adequate for forming the at least one floor plate 52 is hereby contemplated for use. Other materials include, but are not limited to, hollow tube, polymers, enhanced polymers, other metal materials, composites, or any combination thereof.

### Safety Area:

In the arrangement shown, as one example, system 10 is used in association with a safety area 64. Safety area 64 may be formed of any suitable size, shape and design and is configured to provide an area of refuge for offspring to live in and retreat to. The safety area 64 prevents injury or death risk due to the parent's size during movement, such as laying down. For example, the safety area 64 provides a refuge area for piglets to escape to in the presence of a sow. However, it is to be noted that the system 10 may be utilized in connection with any type of animal or livestock without departing from the scope of the disclosure. In the arrangement shown, as one example, two safety areas 64, also referred to as “piglet areas”, are located adjacent to the confinement area 90. In the arrangement shown, as one example, a safety area 64 is an area that the adult livestock is prevented from moving into as the adult livestock is to remain within the confinement area 90. In the arrangement shown, as one example, only a piglet or a much smaller livestock can pass through the lower portion of the opposing sidewalls 134 of the crate 124. Thus, in this arrangement, a safety area 64 for the piglets is created.

In the arrangement shown, as one example, safety area 64 is formed by a safety area floor 66 which includes at least one safety area floor panel 68. In the arrangement shown, as one example, the safety area 64 is a rectangular, flat shape which is adjacent to, and relatively level with, the confinement area 90 and the floor 20. In the arrangement shown, as one example, the safety area 64 is large enough to house an entire litter of piglets such that the piglets can escape the confinement area 90. In the arrangement shown, as one example, the safety area 64 is designed as a bio-secure area where piglets can safely nurse.

In the arrangement shown, as one example, the safety area 64 is formed of a safety area floor 66 which comprises safety area floor panels 68 with holes 78. In this arrangement, the holes 78 allow bio-waste to pass through the safety area floor panels 68 and into a bio-waste containment pit 12. In the arrangement shown, as one example, the safety area 64 is configured above a bio-waste containment pit 12 such that gravitational force can pull contaminants from the safety area 64 and into the contaminant pit 12. In the arrangement shown, as one example, the safety area 64 is surrounded along three sides by nursery panels 112. Nursery panels 112 are further described herein. In the arrangement shown, as one example, the nursery panels 112 form three sides of the safety area 64 while the fourth side abuts the confinement area 90.

In the arrangement shown, as one example, floor deck assembly 22 includes two types of bio-secure floor panels 68/94. In the arrangement shown, as one example, the confinement area floor 92, which houses the sow or livestock, uses a confinement area floor panel 94 which is designed to overlap and interlock with the safety area 64 safety panels 68.

### Safety Area Floor Panel:

In the arrangement shown, as one example, floor system 10 is used in association with at least one safety area floor panel 68. The safety area floor panel 68 may also be referred to as a safety panel 68 without departing from the disclosure. Safety area floor panel 68 may be formed of any suitable size, shape and design and is configured to form the safety floor 66 of the safety area 64. In the arrangement shown, as one example, safety area floor panel 68 has a top 70, a bottom 72, a sidewall 74, a nursery panel slot 76, at least one hole 78, at least one notch 80, at least one beam slot 82, at least one tab connector 84, at least one confinement area floor panel notch 86, and at least one end rod hole 88.

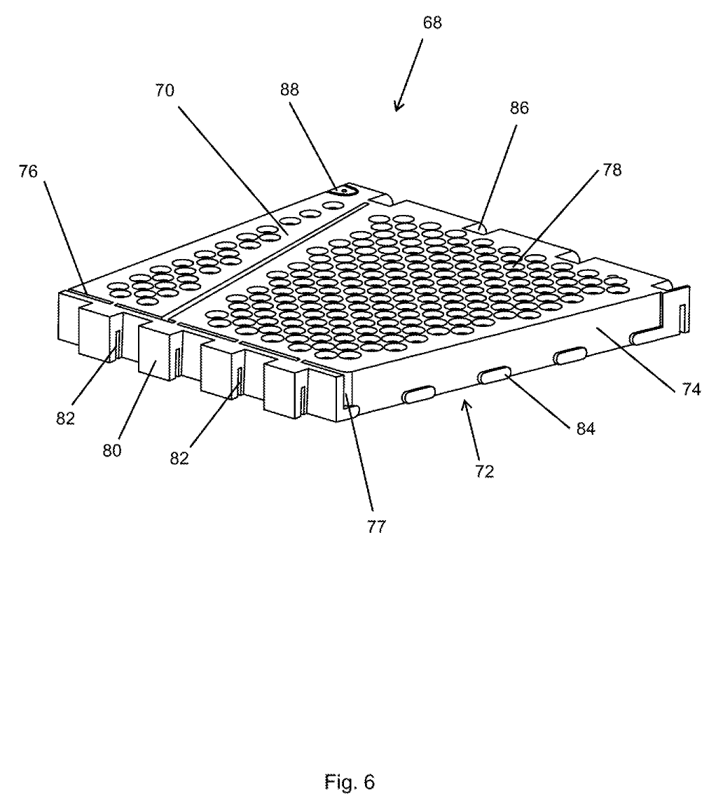

In the arrangement shown, as one example, safety area floor panel 68 is configured to provide a bio-secure safety area floor 66 for the safety area 64. Additionally, in the arrangement shown, as one example, safety area floor panel 68 is designed to be easily assembled and disassembled with little to no tools required. In the arrangement shown, as one example, with reference to FIG. 6, a safety area floor panel 68 is generally flat and square and is designed to be configured with a plurality of safety area floor panels 68, if desired. Additionally, in the arrangement shown, as one example, the safety area floor panel 68 is specifically designed to meet animal footing requirements. However, this is only one example of animal footing requirements. Other arrangements and sizes of features of the safety area floor panel 68 which meet other animal footing requirements are hereby contemplated for use.

Nursery Panel Slot: In the arrangement shown, as one example, safety area floor panel 68 includes at least one nursery panel slot 76/77. The nursery panel slot 76/77 may also be referred to as a guard slot 76/77 without departing from the disclosure. Nursery panel slot 76/77 is formed of any suitable size, shape and design and is configured to receive a nursery panel 112 therein. Nursery panel 112 is further described herein. In one arrangement, as one example, the nursery panel slots 76/77 comprise a parallel slot 76 which runs parallel to the surface 80 and an angle slot 77 which is at an angle to the parallel slots 76 and extends through the bio-waste holes. In the arrangement shown, as one example, nursery panel slots 76/77 are a slender slot along the top 70 of the safety area floor panel 68 designed to receive the nursery panel 112 in close and tight tolerances. Located within the at least one nursery panel slots 76/77 is the at least one extruded tab 84 that extends, as shown, perpendicular from one side of the nursery panel slot 76/77 to the parallel slot 76 side. The extruded tab 84 will have geometry that performs as a rigid strike plate. The extruded tab 84 will guide, expand, and retain with significant retraction force that the nursery panel 112 flexible members 122 secure the nursery panel 112 to the safety area floor panel 68. The plurality of nursery panel slots 76/77 allow for the containment of the safety area with a singular nursery panel part number use in sets of one, two, three, four, five, six, seven, eight, nine, or more combinations. Furthermore, the multiple nursery panel slots 76/77 insure the safety area floor panels 68 can be assembled in any sequence; the required part numbers for a complete installation is one; and manufacturing tooling costs are minimized due to nursery panel 112 being used in multiple locations. In this way, no tools are necessary to attach a nursery panel 112 to the safety area floor panel 68; the nursery panel 112 merely needs to be inserted into the nursery panel slot 76/77 and snapped in place.

Hole: In the arrangement shown, as one example, safety area floor panel 68 includes a plurality of holes 78. Holes 78 are formed of any suitable size, shape and design and are configured to provide an opening in the safety area floor panel 68 extending from the top 70 to the bottom 72 so that air and bio-waste can pass through the safety area floor panel 68. In the arrangement shown, as one example, the safety area floor panel 68 includes a plurality of circular openings, or holes 78, which allow air, bio-waste, water, and other debris or cleaning solutions to pass through the safety panel 68. In this way, a very bio-secure safety panel 68 is created which does not cause build-up of contaminants in the safety area 64.

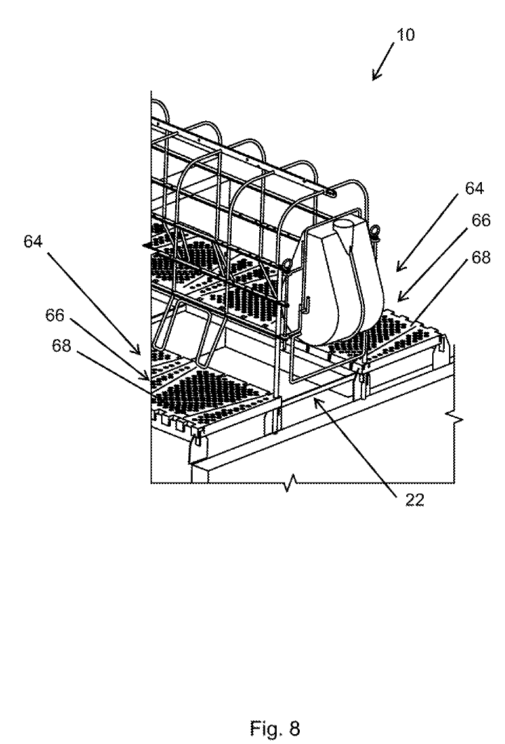

Notch/Interlocks: In the arrangement shown, as one example, safety area floor panel 68 includes a plurality of incrementally spaced interlocks or notches 80. Interlocks 80 allow the connecting of the at least one safety area floor panels 68 of one, two, three, four, five, six, seven, eight, nine, or more farrowing crate assemblies or floor systems 10 in a continuous row. The safety area floor panels 68 incremental design allows adjacent safety area floor panels 68 to share a common beam 24. Interlocks 80 are formed of any suitable size, shape, spacing, and design and are configured to interlock the safety area floor panel 68 with other safety area floor panels 68 in multiple directions. Any number of safety area floor panels 68 can be interlocked together without departing from the scope of the disclosure. Additionally, in the arrangement shown, as one example, interlocks 80 also includes a beam slot 82 located on the bottom side of the interlock 80. In the arrangement shown, as one example, and with reference to FIG. 8, interlock 80 also provides support to the safety area floor panel 68 by connecting the safety area floor panel 68 to the beam 24.

In the arrangement shown, as one example, a plurality of interlocks 80 facilitate the connection of the safety area floor panel 68 to the beam 24 via a beam slot 82 located on the bottom side of the plurality of interlocks 80. In the arrangement shown, as one example, beam slot 82 is formed of any suitable size, shape and design and is configured to receive a beam 24 in close and tight tolerances so as to facilitate in attaching a safety area floor panel 68 to a beam 24 without the need for tools.

Tab Connector: In the arrangement shown, as one example, safety area floor panel 68 may include at least one tab connector 84. Tab connector 84 is formed of any suitable size, shape and design and is configured to connect adjacent safety area floor panels 68 installed parallel and relatively between two or more beams 24.

In the arrangement shown, as one example, tab connector 84 is a generally oval-like extension from the lower part of sidewall 74 of the safety area floor panel 68. On the opposing side, a matching receptacle slides over the oval tab connector 84 and locks multiple safety area floor panels 68 into a continuous floor section. In this arrangement, as in shown, in one example, assembly and disassembly can take place efficiently and without tools.

Confinement Area Floor Panel Beam Notch: In the arrangement shown, as one example, safety area floor panel 68 includes at least one confinement area floor panel notch 86. The at least one confinement area floor panel notch 86 is formed of any suitable size, shape and design and are configured to allow the structural rib 108 to pass through the safety area floor panel 68 and capture the beam 24. Furthermore, the rib 108 and safety area floor panel 68 are now combined. Tab 106 and confinement area floor panel 94 are further described herein.

In the arrangement shown, as one example, the at least one confinement area floor panel notch 86 is located in the sidewall 74 of the safety area floor panel 68 and is configured to be adjacent to the confinement area 90 such that a confinement panel 94 can engage and interlock with the safety area floor panel 68 and beam 24. In addition, the confinement area floor panel 94 mates the bottom surface with the top surface of the at least one safety area floor panel 68. Weight from the sow prevents the vertical dislodging of the total floor assembly.

End Rod Hole: In the arrangement shown, as one example, safety area floor panel 68 includes an end rod hole 88. End rod hole 88 is formed of any suitable size, shape and design and is configured to secure the bio-secure safety area floor panel 68 to the end rod 142. Additionally, in the arrangement shown, as one example, end rod hole 88 is configured to allow the end rod 142 to pass through the safety area floor panel 68; connecting the crate 124 to the floor plate 52 below. The end rod hole 88 may be a secondary light manufacturing process, such as a knockout in an electrical panel and removed as required during installation.

In the arrangement shown, as one example, safety area floor panel 68 is formed of a polymer, non-metallic material. Forming safety area floor panel 68 of a polymer capable of supporting livestock has many advantages. In the arrangement shown, as one example, safety area floor panel 68 can utilize mass production technologies. In the arrangement shown, safety area floor panel 68 is a molded plastic or polymer. In the arrangement shown, as one example, safety area floor panel 68 is formed by injection molding which is a cost-effective high-volume manufacturing solution.

In the arrangement shown, as one example, safety area floor panel 68 can be easily cleaned and prevents bacterial growth, thus further enhancing the biosecurity of floor system 10. However, safety area floor panel 68 may be formed of any material adequate to provide a bio-secure floor strong enough to support livestock. Other materials may include metals, enhanced polymers, and/or a combination of metals and polymers. Additionally, any number of safety area floor panels 68 may be used as the safety area floor panels 68 are designed to be configured in a repeating fashion such that floor systems 10 of varying sizes may be constructed.

In the arrangement shown, as one example, one other feature of the molded polymer is the color. In the arrangement shown, as one example, the safety area floor panel 68 is formed of a dark color so the safety area floor panel 68 may retain heat from a heat lamp or other heat source. In this way, and in the arrangement shown as one example, safety area floor panel 68 maintains a consistent temperature for the piglets or other livestock housed in the safety area 64.

Finally, in the arrangement shown, as one example, a principal concern of current hog confinements is the prevention of rapid disease transmission within the confinement, i.e., bio security. Important in bio security is a safety area floor panel 68 that supports direct flow of bio waste into a waste transmission (bio-waste containment pit 12) system below the floor deck assembly 22. Furthermore, a bio-secure floor system 10 that prevents buildup of waste on the underside spaces of safety area floor panel 68 and floor deck assembly 22, and which cleans easily during and between nursing sows is of vital importance in bio security.

### Nursery Panel:

In the arrangement shown, as one example, floor system 10 is used in association with at least one nursery panel 112. Nursery panel 112 may be formed of any suitable size, shape and design and is configured to form an enclosure around the safety area 64 such that livestock including, but not limited to, piglets are contained within the safety area 64.

In the arrangement shown, as one example, nursery panel 112 includes a top 114, a bottom 116, at least one sidewall 118, a handle 120, and tabs 122. In the arrangement shown, as one example, nursery panel 122 is shaped like a generally flat panel and installed in system 10 with the handle 120 upward. In the arrangement shown, a plurality of nursery panels 112 are utilized to confine livestock within the safety area 64.

Nursery panel 112 may include holes that extrude through the opposing flat surfaces 118. These holes will reduce weight, increase air flow, and reduce material and manufacturing cost. The nursery panel 112 has all edges 114 that could come in contact with barn operators and livestock radiused or formed geometry that will prevent injury during handling or a slip and fall.

The nursery panel 112 has a flexible section 113 that extends from the lower face to the upper face. The flexible section 113 allows installation of the nursery panel 112 as a planar panel; or create a left or right corner section. The flexible section 113 allows for the flat shipping of nursery panels 112 and bent during installation.

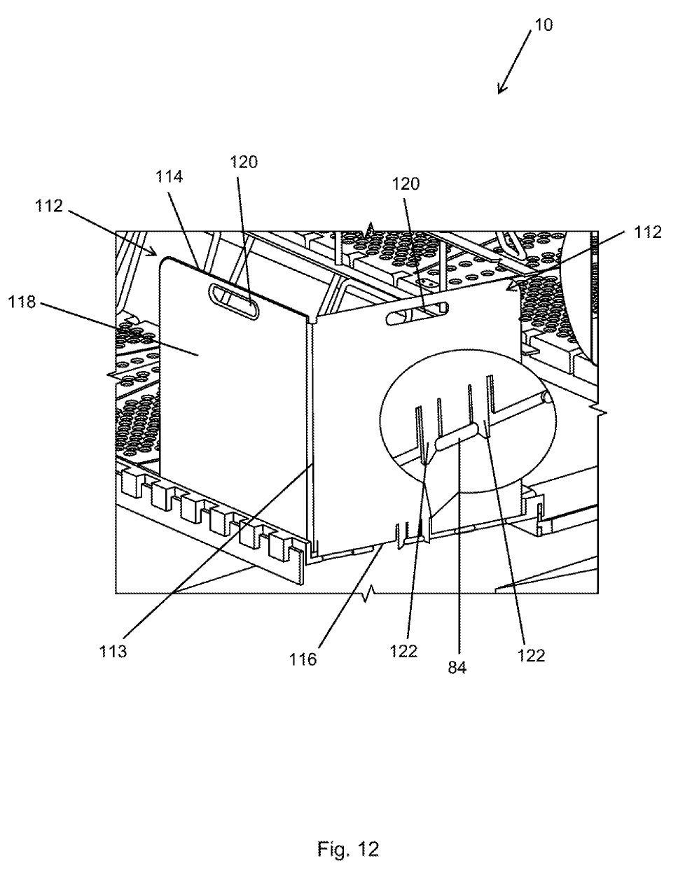

Tabs: In the arrangement shown, as one example, the nursery panel 112 includes tabs 122, attached to the bottom 116 of the nursery panel 112. Tabs 122 are formed of any suitable size, shape and design and are configured to provide a snapping/engaging means for the nursery panel 112 to be clipped to the safety area floor panel 68. In the arrangement shown, and with reference to FIG. 12, tabs 122 consist of two extensions of the sidewall 118 of nursery panel 112 sized and shaped to clip to the tab connector 84 of the safety area floor panel 68. However, tabs 122 may be formed of any size and shape so as to facilitate in the attachment of the nursery panel 112 to the safety area floor panel 68.

### Confinement Area:

In the arrangement shown, as one example, floor system 10 is used in association with a confinement area 90. Confinement area 90 may be formed of any suitable size, shape and design and is configured to house livestock. In the arrangement shown, as one example, confinement area 90 is formed by the components of system 10 which make up the main body of system 10; namely the crate 124, among other components.

In the arrangement shown, as one example, the confinement area 90 includes a rearward end where a sow or other livestock enters the confinement area 90. Additionally, in the arrangement shown, as one example, the confinement area 90 includes a forward end where the sow or livestock faces after entering the confinement area 90. In the arrangement shown, as one example, the forward end of the confinement area 90 houses a feeder 146, such that the sow or other livestock may feed while standing on the at least one confinement area floor panel 94 of the confinement area 90.

In the arrangement shown, as one example, confinement area 90 is generally a rectangular space, similar to a small corridor, with an upper top surface formed by the upper portions of the crate 124, which extend above the confinement area 90. In the arrangement shown, as one example, confinement area 90 is shaped to house a sow in a manner which a full grown sow cannot turn around in the confinement area 90. In the arrangement shown, as one example, confinement area 90 is shaped and sized so a sow can stand up and lay down. Additionally, confinement area 90 is shaped and sized so a sow can nurse piglets confined in an adjoining safety area 64. However, other shapes and sizes are hereby contemplated for use, including shapes and sizes for various livestock, and for various quantities of livestock.

### Confinement Area Floor Panel:

In the arrangement shown, as one example, floor system 10 is used in association with at least one confinement area floor panel 94. Confinement area floor panel 94 may be formed of any suitable size, shape and design and is configured to form the confinement floor 92 of the confinement area 90. In the arrangement shown, as one example, confinement area floor panel 94 includes a top 96, a bottom 98, a sidewall 100, at least one hole 104, at least one tab 106, at least one notch 108, and at least one beam slot 110.

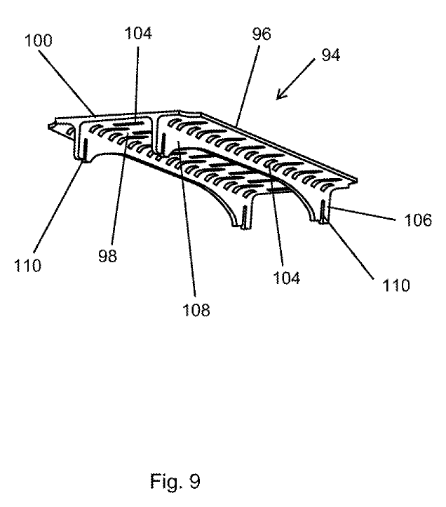

In the arrangement shown, as one example, confinement area floor panel 94 is configured to provide a bio-secure confinement floor 92 for the confinement area 90. Additionally, in the arrangement shown, as one example, confinement area floor panel 94 is designed to be easily assembled and disassembled with little to no tools required. In the arrangement shown, as one example, with reference to FIG. 9, a confinement area floor panel 94 is generally flat and square and designed to be configured with a plurality of confinement area floor panels 94, if desired. Additionally, in the arrangement shown, as one example, the confinement area floor panel 94 is specifically designed to meet animal footing requirements. However, this is only one example of animal footing requirements. Other arrangements and sizes of features of the confinement area floor panel 94 which meet other animal footing requirements are hereby contemplated for use.

Hole: In the arrangement shown, as one example, confinement area floor panel 94 includes a plurality of holes 104. Holes 104 are formed of any suitable size, shape and design and are configured to provide an opening in the confinement panel 94 extending from the top 96 to the bottom 98 so that air and bio-waste can pass through the confinement area floor panel 94. In the arrangement shown, as one example, the confinement area floor panel 94 includes a plurality of openings, or holes 104, which allow air, bio-waste, water, and other debris or cleaning solutions to pass through the confinement area floor panel 94. In this way, a very bio-secure confinement area floor panel 94 is created which does not cause build-up of contaminants in the confinement area 90. Any number of openings or holes 104 may be utilized in the confinement area floor panel 94 without departing from the disclosure. For example, one, two, three, four, five, six, seven, eight, nine, ten, twenty, thirty, forty, or more holes 104 may be included in the confinement area floor panel 94.

Interlocks of Confinement Area Floor Panel: In the arrangement shown, as one example, a confinement area floor panel 94 includes a plurality of interlocks or notches 108. Interlocks of the confinement area floor panel 108 are formed of any suitable size, shape and design and are configured to interlock confinement area floor panel 94 with safety area floor panel 68. In the arrangement shown, as one example, interlocks of the confinement area floor panel 108 extend the length of the confinement area floor panel 94 adding structure to the confinement area floor panel 94 as well as providing a tab 106 and a beam slot 110. Any number of interlocks or notches 108 may be included in a confinement area floor panel 94 without departing from the disclosure. For example, one, two, three, four, five, six, seven, eight, nine, or more interlocks or notches 108 may be included in a confinement area floor panel 94.

Tab: In the arrangement shown, as one example, confinement area floor panel 94 includes a plurality of tabs 106. Tabs 106 are formed of any suitable size, shape and design and are configured to interlock the confinement area floor panel 94 with the safety panel 68. In the arrangement shown, as one example, tab 106 is sized and shaped to fit in close and tight tolerances with the confinement area floor panel notch 86 so as to be inserted into the safety area floor panel 68. Any number of tabs 106 may be included in a confinement area floor panel 94 without departing from the disclosure.

Beam Slot: In the arrangement shown, as one example, interlocks 108 include a beam slot 110. Beam slot 110 is formed of any suitable size, shape and design and is configured to receive a beam 24 in close and tight tolerances so as to facilitate in attaching a confinement area floor panel 94 to the safety area floor panel 68 or to a beam 24 without the need for tools.

In the arrangement shown, as one example, confinement area floor panel 94 is formed of a polymer. Forming confinement area floor panel 94 of a polymer capable of supporting livestock has many advantages. In the arrangement shown, as one example, confinement area floor panel 94 can be mass produced in automated systems.

In the arrangement shown, as one example, confinement area floor panel 94 can be easily cleaned and prevents bacterial growth, thus further enhancing the biosecurity of floor system 10. However, confinement area floor panel 94 may be formed of any material adequate to provide a bio-secure floor strong enough to support livestock. Other materials may include metals, enhanced polymers, and/or a combination of metals and polymers. Additionally, any numbers of confinement area floor panels 94 may be used as the confinement panel 94 are designed to be configured in a repeating fashion such that floor systems 10 of varying sizes can be constructed.

Finally, in the arrangement shown, as one example, a principal concern of current hog confinements is the prevention of rapid disease transmission within the confinement, i.e., bio security. Important in bio security is a confinement area floor panel 94 that supports direct flow of bio-waste into the bio-waste containment pit 12 below the floor deck assembly 22. Furthermore, a bio-secure floor system 10 that prevents buildup of waste on the underside spaces of confinement area floor panel 94 and floor deck assembly 22, and which cleans easily between nursing sows is of vital importance in bio security.

### Crate:

In the arrangement shown, as one example, system 10 is used in association with a crate 124. Crate 124 may be formed of any suitable size, shape and design and is configured to provide a confinement area for the 3-dimensional, structural confinement area for the livestock. In the arrangement shown, as one example, crate 124 is configured to provide a physical barrier between the safety area 64 and the confinement area 90. In the arrangement shown, as one example, crate 124 has a top 126, a bottom 128, a front 130, a back 132, and opposing sidewalls 134.

In the arrangement shown, as one example, crate 124 is formed of at least one Flying-W 136, at least one horizontal plate 138, at least one center plate 140, and at least one end rod 142. Additionally, crate 124 may include at least one door 144.

Rib (Flying-W): In the arrangement shown, as one example, system 10 is used in association with at least one Flying-W 136. The at least one Flying-W 136 may be formed of any suitable size, shape and design and is configured to provide the 3-dimensional, structural design of the main body of the confining crate 124. The at least one Flying-W 136, also referred to as at least one rib 136, is configured to create the new and important structural strength for the crate 124. In other words, the Flying-W 136 is configured to provide the crate 124 with its shape. Said yet another way, the Flying-W 136 is configured to provide the crate 124 with its strength. Furthermore, a main function of the Flying-W 136 is also to create an easy means of assembly of a crate 124. Furthermore, said in one other way, the Flying-W 136 is configured to structurally increase the integrity, rigidity, and durability of a crate 124. These functions, as well as others, are hereby contemplated for use.

The Flying-W 136 comprises a solid sectional profile, which may also be formed with materials having an inner sectional profile and an outer sectional profile. The Flying-W 136 is configured to create the structural strength of the crate 124. Furthermore, in one arrangement, as one example, the lower portion of the Flying-W 136 may include components in multiple planes which are welded to opposing and parallel surfaces of the at least one horizontal plate in order to increase structural strength with less material.

In the arrangement shown, as one example, the Flying-W 136 includes a upper portion which is generally formed of an arc. The Flying-W 136 includes a middle portion which is generally formed of a plane extending from a top horizontal plate 138 to a bottom horizontal plate 138. The Flying-W 136 includes a lower portion which is shaped like a “W”. However, any shape or configuration is hereby contemplated for use without departing from the disclosure.

In the arrangement shown, as one example, the Flying-W 136 is formed in a shape that looks like a “W”, i.e., the origin of the Flying-W naming. In this arrangement, the “W” forms the lower portion of the Flying-W 136. In the arrangement shown, as one example, the Flying-W 136 is formed of a continuous bar, shaped to form an opposing wall 134 of the crate 124. In this way, in the arrangement shown, as one example, the Flying-W 136 gives the confinement area 90 its shape.

In the arrangement shown, as one example, a Flying-W 136 shape forms half the structure of the crate 124. However, other shapes are hereby contemplated for use that may be configured to provide stability and safety. Furthermore, other shapes, which may form the crate 124, or in other words both sides of the crate 124, are hereby contemplated for use. Other shapes may be any three-dimensional shape of forming a continuous or rebar wire which can extend through positioning holes and provide an easy to configure rib cage of the crate 124.

In the arrangement shown, as one example, the Flying-W 136 is formed of a size that allows for the crate 124 to be utilized as a farrowing crate which can comfortably house a single sow. However, any other size of the Flying-W 136 is hereby contemplated for use without departing from the disclosure. Additionally, the thickness of the continuous wire, which forms the Flying-W 136, is comprised of a size that provides strength in order to contain a sow in a safe manner. However, any other size of continuous wire is hereby contemplated for use without departing from the disclosure.

In the arrangement shown, as one example, three Flying-W 136 configurations are used to provide a stable crate 124. However, any number of Flying-W 136 configurations may be used to configure an appropriately sized crate 124 without departing from the disclosure. For example, the crate 124 may comprise one, two, three, four, five, six, seven, eight, nine, ten, or more Flying-W 136 configurations.

Furthermore, in the arrangement shown, as one example, the Flying-W 136 is sized so that the bottom, horizontal portion of the lower portion of the Flying-W 136 does not contact the safety area floor 66 or the confinement area floor 92. In this arrangement, a piglet can fit underneath the lower portion of the Flying-W 136. It is important to note that the term “piglets” is utilized throughout the disclosure. However, the term “piglets” shall be interpreted to mean any type of offspring of any livestock without departing from the scope of the disclosure.

In the arrangement shown, as one example, the bottom of the lower portion of the Flying-W 136 is approximately 2-5 inches from the floor. However, the bottom of the lower portion of the Flying-W 136 may be any distance from the floor without departing from the scope of the disclosure. However, other arrangements are hereby contemplated for use. For example, the bottom of the Flying-W 136 may be sized to be in contact with the floor 20, or the Flying-W 136 may be sized to be several feet or more, or anything in between such as larger piglets or other livestock can fit underneath the Flying-W 136 configuration of the lower portion. Furthermore, the lower portion of the Flying-W 136 is sized such that a piglet could fit in between the two “U” extensions which form the lower portion. However, any other size of “W” configuration or other shape is hereby contemplated for use without departing from the disclosure.

In the arrangement shown, as one example, the Flying-W 136 is designed to provide a stable structure for the crate 124 while also providing a safe structure. In this arrangement, the design of the Flying-W 136 must be strong and rigid, yet flexible so as to limit negative interactions, such as when a sow collides with an interior component of crate 124. In this way, the design of the Flying-W 136 is such that the bar has some flexibility such that a sow or piglet could collide with the bar with minimized injury and/or stress risk, but so that the continuous wire still confines a large sow.

In the arrangement shown, as one example, the Flying-W 136 is located or positioned so as to form the main body of the cage of the crate 124. In the arrangement shown, as one example, three Flying-W 136 are positioned an equal distance from one another along the length of the center plate 140 and the horizontal plates 138. In the arrangement shown, as one example, the Flying-W 136 is positioned such that it is operably connected to the at least one horizontal plate 138.

Horizontal Plate: In the arrangement shown, as one example, the crate 124 is used in association with at least one horizontal plate 138. The at least one horizontal plate 138 may be formed of any suitable size, shape and design and is configured to provide horizontal support to the Flying-W 136. In other words, as is shown in the example, horizontal plate 138 is configured to increase the structural strength of the crate 124. The structural strength of the crate 124 may be increased, if necessary, by increasing the number of horizontal plates 138 used in the crate 124.

Additionally, horizontal plate 138 may be configured as a support feature of other components of system 10 and crate 124. Some of these features include, but are not limited to, doors 144, end rods 142, water trees, heat lamps, sensors 148, among other components or features.

In the arrangement shown, as one example, the at least one horizontal plate 138 is a generally flat, rectangular, bar extending a length from a first end, to a second end. In the arrangement shown, as one example, horizontal plate 138 has a plurality of positioning holes which extend through the horizontal plate 138 from the top to the bottom.

In the arrangement shown, as one example, the at least one horizontal plate 138 is designed to provide stability and support to the crate 124. In the arrangement as is shown, the at least one horizontal plate 138 is designed to prevent, or limit, horizontal movement of the Flying-W 136. In this way, the at least one horizontal plate 138 prevents the Flying-W 136 from moving horizontally by enclosing the Flying-W 136 in one, or more, of a plurality of positioning holes. Additionally, in the arrangement shown, as one example, the horizontal plate 138 is stabilized at each end by an end rod 142 which transfers any horizontal forces applied to the horizontal plate 138 to the ground. The end rod 142 is further described herein.

In the arrangement shown, as one example, a plurality of horizontal plates 138 form part of the opposing sidewalls 134 of the crate 124, or in other words the walls of the confinement area 90. In this arrangement, as is shown, a plurality of horizontal plates 138 are spaced opposite a vertical plane following the center plate 140.

In the arrangement shown, as one example, the at least one horizontal plate 138 is attached to other features of the crate 124 by welding. However, any other type or form of attachment means is hereby contemplated for use including, but not limited to, friction fit, bolting, threading, gluing, and the like. Furthermore, in the arrangement shown, as one example, six horizontal plates 138 are used in the design of the crate 124. However, any number of horizontal plates 138 is hereby contemplated for use including one, two, three, four, five, six, seven, eight, nine, ten, or more horizontal plates 138.

In the arrangement shown, as one example, the at least one horizontal plate 138 is made from flattened or plated steel. However, any other material which is adequate for forming the at least one horizontal plate 138 is hereby contemplated for use without departing from the scope of the disclosure. Other materials include, but are not limited to, hollow tube, polymers, enhanced polymers, other metal materials, composites, and/or any combination thereof.

Center Plate: In the arrangement shown, as one example, crate 124 is used in association with a center plate 140. Center plate 140 may be formed of any suitable size, shape and design and is configured to connect the opposing sides of the main body (formed by the Flying-W 136) and to stabilize the crate 124. In other words, the at least one center plate 140 is configured like a spine, connected to each of the Flying-W 136 configurations. In the arrangement shown, as one example, the at least one center plate 140 is configured to provide both vertical and horizontal support to the Flying-W 136 configurations. In other words, as is shown in the example, center plate 140 is configured to increase the structural strength of the crate 124. The structural strength of the crate 124 can be increased, if necessary, by adding a plurality of center plates 140. Conversely, an alternative arrangement may not have a center plate 140.

Additionally, in the arrangement shown, as one example, center plate 140 is configured as a containment feature of the crate 124. Where the horizontal plate 138 is configured to contain the sow along the sides of the crate 124, the center plate 140 is configured to contain along the top of crate 124. In the arrangement shown, as one example, center plate 140 is also configured to house, and/or attach, other features of the crate 124.

In the arrangement shown, as one example, the center plate 140 is similar in size, shape and design to the at least one horizontal plate 138. In the arrangement shown, as one example, the at least one center plate 140 is slender or thin. In the arrangement shown, as one example, the center plate 140 is comprised of a size to provide an adequate space for a sow from at least the nose to the tail of the sow. However, any other size and length of center plate 140 is hereby contemplated for use without departing from the disclosure. For example, a center plate 140 which is formed of a length long enough to house one, two, three, four, five, six, seven, eight, nine, ten, or more sows is hereby contemplated for use.

In the arrangement shown, as one example, the at least one center plate 140 is made from flattened or plated steel. However, any other material which is adequate for forming the at least one center plate 140 is hereby contemplated for use. Other materials include, but are not limited to, hollow tube, polymers, enhanced polymers, other metal materials, composites, or any combination thereof.

In an alternative embodiment, the at least one center plate 140 may be configured to connect and/or support multiple crates 124 arranged side by side, in either or both of a length and/or width arrangement. Additionally, at least one center plate 140 may be used as providing a connection and webbing for a plurality of crates 124.

End Rod: In the arrangement shown, as one example, system 10 is used in association with at least one end rod 142. At least one end rod 142 may be formed of any suitable size, shape and design and is configured to stabilize each corner of system 10. Additionally, in the arrangement shown, as one example, the at least one end rod 142 is configured to attach the main body of the confinement crate 124 to the floor 20. In the arrangement shown, as one example, end rod 142 is configured to attach to the end of the horizontal plate 138 to provide support and stabilize the horizontal plate 138. Additionally, end rod 142 is configured to transfer any forces on the above main body of the confinement crate 124 to the floor 20 through the floor plate 52 and the lip or shelf 14.

In the arrangement shown, as one example, end rod 142 is a continuous rod or wire which extends a length from a first end to a second end. In the arrangement shown, as one example, end rod 142 is a circular rod or circular tube which is shaped in a straight fashion extending from the floor plate 52 to the crate 124.

In the arrangement shown, as one example, end rod 142 is stainless steel or steel to provide a robust resistance to the acidity of animal bio-waste. However, end rod 142 may be formed of any other material adequate to support the other components of system 10. Any other material used for end rod 142 is hereby contemplated for use. Other materials include, but are not limited to rebar, hollow tube, polymers, enhanced polymers, other metal materials, composites, or any combination thereof.

Door(s): In the arrangement shown, as one example, crate 124 is used in association with a door 144. Door 144 may be formed of any suitable size, shape and design and is configured to provide an entrance and/or exit for livestock to enter the confinement area 90 of system 10. In the arrangement shown, as one example, more than one door 144 may be used for this purpose.

In the arrangement shown, as one example, door 144 is generally flat and rectangular and is configured to provide an enclosure to keep livestock from escaping the confinement area 90 and/or to keep unwanted livestock from entering the confinement area 90. In the arrangement shown, as one example, door 144 is hingedly connected to crate 124. However, other arrangements of a door 144 and/or other connections for door 144 to system 10 are hereby contemplated for use.

In the arrangement shown, as one example, the door 144 is made from steel panels and/or stainless steel rods and wire. However, any other material which is adequate for forming the door 144 is hereby contemplated for use without departing from the disclosure. Other materials include, but are not limited to, rebar, hollow tube, polymers, enhanced polymers, other metal materials, composites, or any combination thereof.

### Other Features:

Feeder: In the arrangement shown, as one example, crate 124 may be used in association with a feeder 146. Feeder 146 may be formed of any suitable size, shape and design and is configured to feed livestock in the confinement area 90. In the arrangement shown, as one example, the feeder 146 is sized, shaped, and designed to allow a sow and other livestock to consume food.

In the arrangement shown, as one example, feeder 146 is located and forms the panel portion of a door 144. In this way, the feeder 146 is at the front of the crate 124. As is shown in one example, the sow or other livestock in the confinement area 90 is able to feed from the feeder 146 while standing in the confinement area 90.

Sensor: In the arrangement shown, as one example, system 10 may be use in association with at least one sensor 148. Sensor 148 may be formed of any suitable size, shape and design and is configured to detect environmental conditions of system 10. Furthermore, sensors 148 may be joined with other components which help relay that information to a controller or other device, such as a programmable logic controller. Any number of sensors 148 may be utilized by system 10 to detect any number of variables. For example, the system 10 may comprise one, two, three, four, five, six, seven, eight, nine, ten, or more sensors 148. Some sensor 148 types may include, but are not limited to, force sensors, pressure sensors, motion sensors, temperature sensors, reflex sensors, water level sensors, food level sensors, heart rate sensors, positioning sensors, weight sensors, contaminant detection and monitoring sensors, bio-waste containment pit 12 level sensors, and more. Furthermore, sensor 148 may be used in conjunction with a hardware management system 150.

Hardware Management System: In the arrangement shown, as one example, system 10 is used in association with a hardware management system 150. Hardware management system 150 may be formed of any suitable size, shape and design and is configured to assist a user and/or automatically control environmental conditions and/or variables of system 10. Furthermore, hardware management system 150 may include an application 152 which is run by a user, potentially a user accessing a mobile device and/or other computer and/or other programmable logic controller.

### Installation:

In the arrangement shown, as one example, floor system 10 is easy to install and provides novel installation features which solve long-standing needs in the art. In the arrangement shown, as one example, installation of system 10 in a barn requires only five to seven bolts, making installation the simplest in the industry. In the arrangement shown, as one example, all other components or optional components of system 10 merely drop-in and/or are retained with clips requiring no tools for assembly.

In the arrangement shown, as one example, modern high volume manufacturing is used to minimize parts count, eliminate all or most welding, maximize part functionality and reduce and/or eliminate direct labor cost during manufacturing, installation and utilization. In the arrangement shown, as one example, manufacturing methods include, but are not limited to, CNC wire bending, die stamping, progressive die stamping, die forming, wire straightening, CNC laser cutting, injection molding, automatic sand casting, and robotic welding, among other automated systems. In the arrangement shown, as one example, high functional value is engineered into every component of system 10. In the arrangement shown, as one example, high engineering value is optimized for strength and minimization of the weight of every component of system 10. In the arrangement shown, as one example, cost is greatly reduced by engineering, installation and assembly methods described herein.

In the arrangement shown, as one example, floor plates 52 are first attached to each end 32 of a beam 24. The floor plates 52 and the beam 24 are then placed on the lip or shelf 14 of the bio-waste containment pit 12. Bio-waste containment pit 12 may be poured in place or dug in place. Alternatively bio-waste containment pit 12 may be a polymer form set in place.

Once the beams 24 are in place, a plurality of stiffeners 38 are attached to the beams 24 to stabilize the beams 24. Next, safety area floor panels 68 are attached to the floor deck assembly 22 by sliding the safety area floor panels 68 onto the beams 24 such that the beams 24 line up with the beam slots 82 of the safety area floor panels 68. Following installation of the safety area floor panel 68, the confinement area floor panels 94 are installed. In the arrangement shown, as one example, the confinement area floor panels 94 are installed in a similar fashion to the safety area floor panels 68. In the arrangement shown, as one example, the confinement area floor panels 64 are installed such that the confinement area floor panel 94 overlaps the safety area floor panel 68 to ensure no gaps in the system 10. The crate 124 or other confinement system may be installed above the bio-secure floor.

### In Operation:

In the arrangement shown, as one example, once system 10 is assembled, livestock are moved into the crate 124 and/or confinement area 90. Furthermore, in the arrangement shown, as one example, a litter of piglets could be added to the safety area 64 if desired. In this arrangement, as one example, piglets in a safety area 64 would have access to a sow in the confinement area 90. In this arrangement, piglets could nurse but still have a means of escape to the safety area 64 if the sow shifts or decides to lie down in the confinement area 90. Additionally, nursery panels 112 can be clipped into place along the perimeter of the safety area 64 to contain the piglets.

In the arrangement shown, as one example, when the sow or other livestock are housed within the confinement area 90, waste or bio-waste are created. The bio-waste will fall through holes 104 of the confinement area floor panel 94 and/or holes 78 of the safety area floor panel 68 and into a bio-waste containment pit 12. The bio-waste containment pit 12 can be flushed out at any time desired to keep bio-waste from compiling and away from the sow, piglets, and/or other livestock. This bio-secure floor deck assembly 22 prevents bio-waste from accruing in the confinement area 90 and/or in the safety area 64. Additionally, the bio-secure floor prevents bio-waste from building up on the underside of the panels 68/94.

From the above it will be appreciated that the bio-secure floor system 10 provides the following: a bio-secure floor wherein bio-secure means reducing the potential to retain biological elements such as animal waste which host diseases; is easily cleaned which increases bio-security; allows for a sow to stand or lay down without causing injury or death to the piglets caught between the sow and floor structural members; resists dislodging and deformation due to sow pushing, lifting, or gnawing on the structure; resists dislodging and deformation due to body weight and rubbing forces; provides some flex in the system to accommodate the pushing created by the animals without impacting the long-term structure and/or structural integrity of the system; constrains hogs and/or other livestock in a singular and/or plural orientation; limits the hogs vertical motion preventing injury to hog or staff members; allows for proper ventilation; allows for vertical discharge of waste to the pit without potential for entrapment; does not damage sow teats; reduces assembly tools required and/or eliminates the need for assembly tools for onsite assembly or disassembly; utilizes manufacture systems for high production and/or automated processes; optimizes the production cost to primarily materials and equipment depreciation; optimizes or eliminates labor cost; reduces the per crate shipping weight; reduces assembly stack up error associated with welding; minimizes the total unique part count per assembly; minimizes tools required for assembly; minimizes raw material geometric shapes; illustrates a farrowing crate; illustrates an assembly of farrowing crates in a barn; illustrates assembly and integration of a plurality of farrowing crates; illustrates assembly and integration and interlocking of a plurality of farrowing crates in a barn; among countless other advantages and improvements.

It will be appreciated by those skilled in the art that other various modifications could be made to the system without parting from the spirit and scope of this disclosure. All such modifications and changes fall within the scope of the disclosure and the claims and are intended to be covered thereby.

What is claimed:

1. A biosecurity livestock floor system, comprising:
a bio-waste containment pit wherein the bio-waste containment pit includes a bottom and a sidewall;
a floor deck assembly;
wherein the floor deck assembly is comprised of a plurality of floor beams and a plurality of stiffeners;
a confinement area;
wherein the confinement area comprises a confinement area floor;
wherein the confinement area floor is configured to support at least one livestock in the confinement area;
wherein the confinement area floor comprises of at least one confinement area floor panel;
wherein the confinement area floor panel is supported by the floor deck assembly.

2. The system of claim 1, further comprising:
a shelf;
wherein the shelf is configured to receive the floor deck assembly thereby supporting the floor deck assembly.

3. The system of claim 1, further comprising:
a floor plate;
wherein the floor plate is attached to an end of the floor beam by an interlock in the floor beam;
wherein the floor plate is configured to support the floor beam.

4. The system of claim 1, further comprising:
a safety area;
the safety area having a safety area floor comprising at least one safety area floor panel;
wherein the at least one safety area floor panel is connected to the floor deck assembly.

5. The system of claim 1, further comprising:
at least one nursery panel;
wherein the at least one nursery panel is configured to contain livestock within the system.

6. The system of claim 1, further comprising:
a confinement crate;
wherein the confinement crate is configured to confine the at least one livestock in the confinement area.

7. The system of claim 1, further comprising:
a feeder;
wherein the feeder is configured to provide food to the at least one livestock in the confinement area.

8. The system of claim 1, further comprising:
a water tree;
wherein the water tree is configured to provide fluid to the at least one livestock in the confinement area.

9. The system of claim 1, further comprising:
a water tree;
wherein the water tree is configured to provide fluid to a plurality of livestock in an adjoining safety area.

10. The system of claim 1, further comprising:
a heat lamp;
wherein the heat lamp is configured to provide warmth to at least one livestock in the confinement area.

11. The system of claim 1, further comprising:
at least one sensor configured to detect at least one environmental condition of the floor system.

12. The system of claim 1, further comprising:
a hardware management system configured to respond to a data input and cause an output.

13. The system of claim 1, further comprising:
an application;
wherein the application is installed on an electronic device and controlled via a user interface;
wherein the application is wirelessly connected to a hardware management system and configured to wirelessly control the hardware management system.

14. The system of claim 1, further comprising:
wherein the at least one confinement area floor panel further comprises holes configured to allow air and bio-waste to pass through the holes.

15. The system of claim 1, further comprising:
wherein the floor deck assembly further comprises a floor plate;
wherein the floor plate is configured to connect at least one end rod to the floor deck assembly.

16. The system of claim 4, further comprising:
wherein the safety area is positioned adjacent the containment area;
wherein the safety area is configured to house offspring of the livestock contained within the confinement area.

17. The system of claim 1, further comprising:
wherein the bio-waste containment pit is positioned below the confinement area such that bio-waste passes through the floor deck assembly into the bio-waste containment pit.

18. The system of claim 1, wherein the floor deck assembly further comprises:
a floor beam assembly comprised of a plurality of floor beams and a plurality of stiffeners and a plurality of floor plates.

19. The system of claim 4, wherein the floor deck assembly further comprises:
a floor beam assembly comprised of a plurality of floor beams and a plurality of stiffeners;
wherein the at least one confinement area floor panel sits upon the at least one safety area floor panel and interlocks the at least one confinement area floor panel and the at least one safety area floor panel together.

20. The system of claim 4, wherein the floor deck assembly further comprises:
a floor beam assembly comprised of a plurality of floor beams and a plurality of stiffeners;
wherein the at least one confinement area floor panel sits upon the at least one safety area floor panel and interlocks the at least one confinement area floor panel and the at least one safety area floor panel together and to the plurality of floor beams.

21. The system of claim 1, further comprising:
a safety area;
the safety area having a safety area floor comprising at least one safety area floor panel;
wherein the at least one safety area floor panel comprises at least one interlock;
wherein the at least one interlock allows the connecting of two or more safety area floor panels;
wherein the plurality of safety area floor panels share a common beam.

22. The system of claim 1, further comprising:
a safety area;
the safety area having a safety area floor comprising at least one safety area floor panel;
wherein the at least one safety area floor panel interlocks with a safety area floor panel of an adjacent biosecurity livestock floor system creating a continuous row of biosecurity livestock floor systems.

23. A biosecurity livestock floor system, comprising:
a bio-waste containment pit wherein the bio-waste containment pit includes a bottom and a sidewall;
a floor deck assembly;
wherein the floor deck assembly is comprised of a plurality of floor beams and a plurality of stiffeners;
a confinement area;
wherein the confinement area comprises of a confinement area floor;
the confinement area floor configured to enclose a bottom of the confinement area;
wherein the confinement area floor is configured to support a livestock in the confinement area;
wherein the confinement area floor comprises of at least one confinement area floor panel;
wherein the confinement area floor panel is supported by the floor deck assembly;
a safety area;
wherein the safety area comprises of a safety area floor;
wherein the safety area floor is configured to support a plurality of livestock in the safety area;
the safety area floor configured to enclose a bottom of the safety area;
wherein the safety area floor comprises of at least one safety area floor panel;
wherein the safety area floor panel is supported by the floor deck assembly.

24. The system of claim 23, further comprising:
at least one nursery panel;
wherein the at least one nursery panel is configured to contain at least one livestock within the safety area.

25. A biosecurity livestock floor system, comprising:
a bio-waste containment pit wherein the bio-waste containment pit includes a bottom and a sidewall;
a floor deck assembly;
wherein the floor deck assembly is comprised of a plurality of floor beams and a plurality of stiffeners;
a confinement area;
wherein the confinement area comprises of a confinement area floor;
the confinement area floor configured to enclose a bottom of the confinement area;
wherein the confinement area floor is configured to support a livestock in the confinement area;
wherein the confinement area floor comprises of at least one confinement area floor panel;
wherein the confinement area floor panel is supported by the floor deck assembly;
a safety area;
wherein the safety area comprises of a safety area floor;
wherein the safety area floor is configured to support a plurality of livestock in the safety area;
the safety area floor configured to enclose a bottom of the safety area;
wherein the safety area floor comprises of at least one safety area floor panel;
wherein the safety area floor panel is supported by the floor deck assembly;
a confinement crate;
wherein the confinement crate configured to confine livestock in the confinement area.
